(19) United States
(12) Patent Application Publication
(10) Pub. No.: US 2004/0020197 A1
(43) Pub. Date: Feb. 5, 2004

(54) Hydraulic synchronizer

(76) Inventor: Donald L. Cray, Beaverton, OR (US)

Correspondence Address: Mr. Donald L. Cray, 13758 S.W. Pleasant Valley Road, Beaverton, OR, 97007, US

(21) Appl. No.: 10/209,220

(22) Filed: Jul. 30, 2002

(51) Int. Cl. F16D 31/02

(52) U.S. Cl. 60/485

(57) ABSTRACT

A hydraulic synchronizer for a plurality of hydraulic actuators has at least a pair of hydraulic fluid-holding chambers of variable fluid-holding volume. The synchronizer has a number of separate preferred features, each of which is optional depending upon the intended application of the synchronizer. These optional preferred features include an improved fluid passageway arrangement, a pneumatic pressure source, separate relief valves associated with each chamber, the capability to accommodate hydraulic fluid-holding chambers of different fluid-holding volumes concurrently, and the capability to detachably interconnect multiple synchronizer modules.

### BACKGROUND AND SUMMARY OF THE INVENTION

The present invention relates to improvements in a hydraulic synchronizer for a plurality of hydraulic actuators, wherein the synchronizer has at least a pair of hydraulic fluid-holding chambers, each with a variable fluid-holding volume for supplying fluid to a respective hydraulic actuator.

Hydraulic synchronizers of this general type have existed in the past, as evidenced by the synchronizers shown in U.S. Pat. Nos. 3,643,725, 3,776,300, 3,783,620, 4,351,153, and 4,624,126. All of these prior synchronizers have hydraulically powered displacement members each movably mounted in a respective chamber and interconnected by a mechanical connecting assembly so as to expel hydraulic fluid to the respective hydraulic actuators in predetermined relationship to each other despite differences in resistances imposed on the respective actuators. However these prior synchronizers have different drawbacks, depending upon their applications.

For example, the fluid conduits which connect each displacement member of these prior synchronizers to a hydraulic power source are exposed, and could be easily damaged if portability of the synchronizer is required. The need for portability, for example, is encountered in such applications as house-moving, vehicle-transporting, and lifting of loads of all types at variable locations for display, repair, installation, construction, etc.

Where portability of the synchronizer's power source is also required, the size and weight of the prior systems would also be a drawback, particularly since they rely on a hydraulic power source requiring a hydraulic reservoir.

In addition, if the hydraulic actuators of the prior systems become unsynchronized, serious resulting pressure imbalances could damage the synchronizer or the actuators.

Moreover, if the hydraulic actuators are not all of the same fluid cross-section, or if the number of actuators varies significantly from application to application, the prior synchronizers are not readily adaptable to such variations.

Accordingly the present invention is an improved hydraulic synchronizer capable of alleviating one or more of the aforementioned problems, depending on the application.

The foregoing and other objectives, features, and advantages of the invention will be more readily understood upon consideration of the following detailed description, taken in conjunction with the accompanying drawings.

### BRIEF DESCRIPTION OF THE DRAWINGS

FIG. 1 is a perspective view of an exemplary embodiment of a synchronizer module in accordance with the present invention.

FIG. 2 is an enlarged sectional view of the synchronizer module of FIG. 1.

FIG. 3 is a further enlarged, partially diagrammatic detail view of a portion of the synchronizer module of FIG. 2.

FIG. 4 is an exemplary diagrammatic view illustrating the synchronizer module of FIGS. 1-3 with a hydraulic pressure source.

FIG. 5 is an exemplary diagrammatic view illustrating the synchronizer module of FIGS. 1-3 with a pneumatic pressure source.

FIG. 6 is an exemplary diagrammatic view illustrating the interconnection of a pair of synchronizer modules to accommodate an increased number of hydraulic actuators.

FIG. 7 is an exemplary diagrammatic view illustrating a synchronizer module modified to accommodate actuators of differing fluid cross-sections.

### DETAILED DESCRIPTION OF PREFERRED EMBODIMENTS

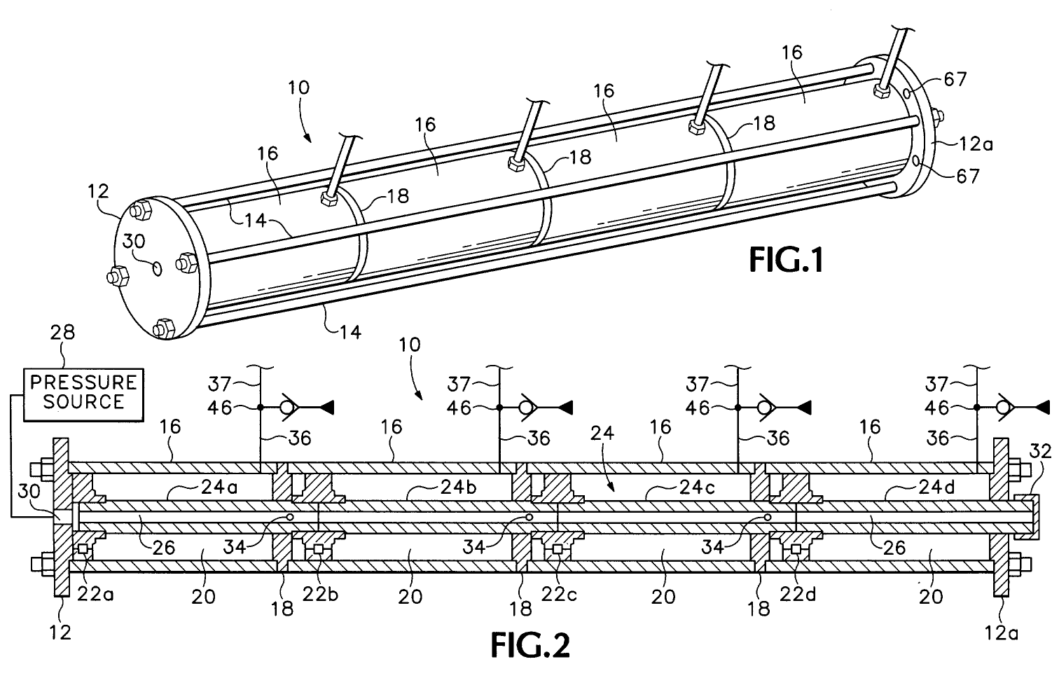

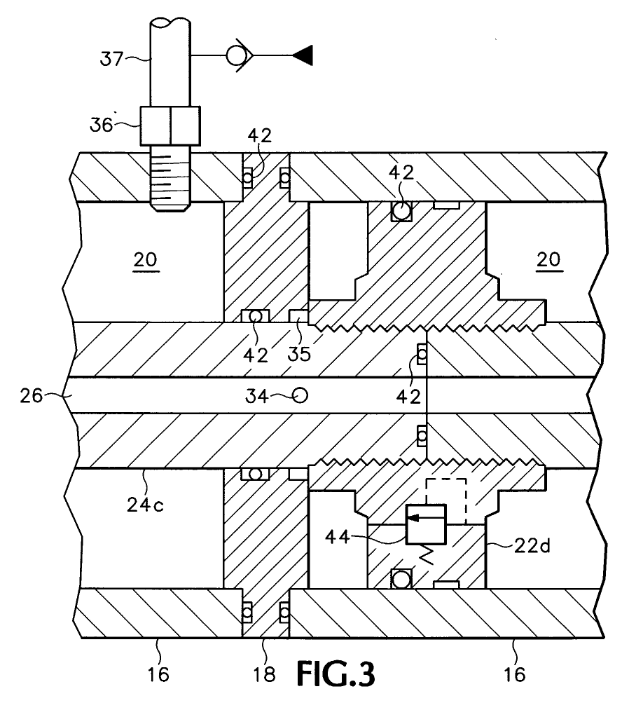

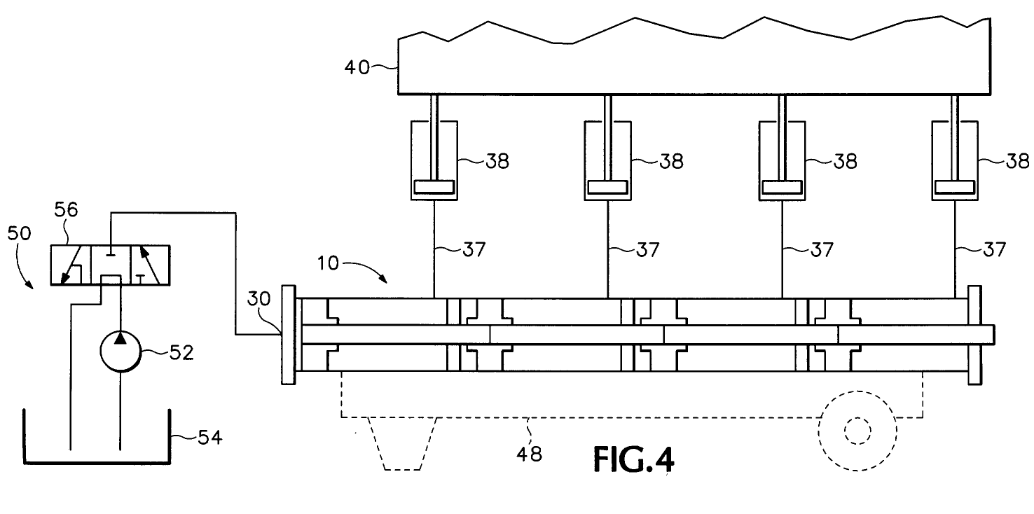

As shown in FIGS. 1-3, an exemplary embodiment of a synchronizer module 10 includes a pair of end flanges 12 and 12a interconnected by respective tension rods 14. Between the end flanges 12 and 12a respective cylindrical housings 16 separated by partitions 18 define respective fluid-holding chambers 20. Each chamber 20 has a respective displacement member 22a, 22b, 22c and 22d, which can be a piston as shown or some other type of displacement member, movably mounted in the respective chamber 20 so as to variably change the fluid-holding volume of the chamber, which is located on the right-hand side of each piston in FIG. 2. The respective displacement members are interconnected by a connecting assembly 24 so as to cause respective movements of the displacement members to be in predetermined relationship to each other despite differences in resistances to their respective movements. In the exemplary embodiment of FIGS. 1-3, the connecting assembly 24 is in the form of a piston rod composed of rod segments 24a, 24b, 24c, 24d threadably coupled together within respective ones of the displacement members 22 so as to rigidly interconnect the displacement members. A fluid passageway 26 is formed within the connecting assembly 24 and receives pressurized fluid from a pressure source 28 through an inlet port 30 formed in the adjacent end flange 12. The opposite end of the fluid passageway 26 is closed by a threaded cap 32. In response to fluid from the pressure source 28, pressurized fluid is directed against the left-hand side of each displacement member 22, directly from the inlet port 30 in the case of the displacement member 22a, and from respective ports 34 in the passageway 26 through annular recesses such as 35 (FIG. 3) in the case of the other displacement members. The fluid pressure thus exerted on the left-hand sides of the respective displacement members forces them to the right in FIG. 2, thereby expelling hydraulic fluid from their respective fluid-holding chambers 20 through respective outlet ports 36 and conduits 37 to respective hydraulic actuators 38, as shown in FIGS. 4-7, to lift a load 40. In most applications, hydraulic fluid is expelled at a uniform volumetric rate from identically-sized chambers 20 due to the interconnection of identically-sized displacement members 22 through the connecting assembly 24, causing hydraulic actuators 38 having identical piston diameters to extend uniformly to lift the load 40. Leakage in the module 10 is minimized by the use of O-rings such as 42 (FIG. 3) between adjacent parts of the module.

Alternative arrangements of the synchronizer system may feature different shapes of the housings 16, different types of displacement members, parallel rather than serial arrangement of the chambers 20 and connecting assembly 24, different fluid passageway arrangements, different types of linear or rotary hydraulic actuators 38, etc.

In some instances, the hydraulic actuators 38 may not be properly synchronized prior to the application of power to the synchronizer module from the pressure source 28. This could be due to incomplete previous retraction of an actuator 38, previous leakage of fluid within the actuator, or placement of the actuators with respect to the load so that different degrees of extension are needed to lift the load. Another possible source of such initial lack of synchronization might be previous leakage within the synchronizer module. In any case, under such circumstances it is possible that one of the actuators 38 will experience excessive resistance to extension, thereby causing excessive pressure in one of the chambers 20 of the synchronizer module. Since such excessive hydraulic pressure could damage the synchronizer module or the hydraulic actuator, it is preferable to provide a respective pressure-relief valve separately for each chamber 20 to enable hydraulic fluid in the chamber to escape through the valve if the pressure in the chamber exceeds a predetermined maximum pressure. Although such a relief valve could be positioned in numerous alternative locations, it is preferably mounted on a respective displacement member 22a, 22b, 22c and 22d as exemplified by relief valve 44 in FIG. 3, so that the escaping fluid is conducted to the opposite side of the displacement member to avoid damage. A replenishment port 46 is preferably provided for each chamber 20 to enable the later introduction of hydraulic fluid into the chamber to replace the fluid which has previously escaped through the relief valve, after the excessive pressure problem has been corrected.

FIG. 4 is a simplified diagrammatic drawing illustrating a typical use of the synchronizer module. 10 in a situation where the module 10 is portably inserted into an existing hydraulic lifting system, such as that used by house movers. In such case the synchronizer module, preferably supported on some suitable type of wheeled transporter 48, is transported to and operably connected between the hydraulic pressure source 50 and the hydraulic actuators 38 of an existing hydraulic system, and operated as described previously. The hydraulic pressure source 50 is conventional, and is shown in simplified form as a hydraulic pump 52 receiving hydraulic fluid from a reservoir 54 and conducting it to the module 10 through a manual control valve 56.

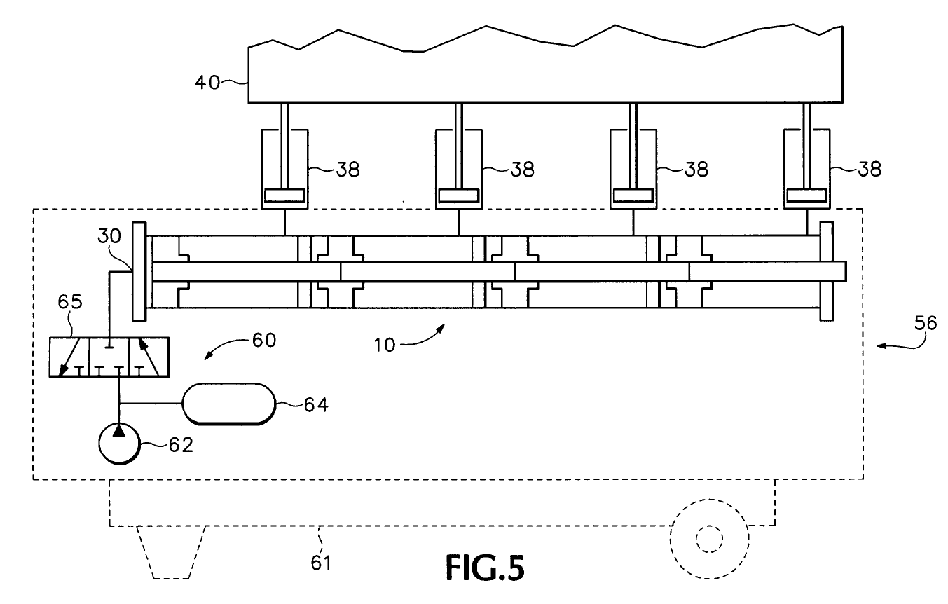

FIG. 5 is a simplified diagrammatic drawing illustrating the use of the module 10 in a portable lift 56 supported on a wheeled transporter 58, where the hydraulic actuators 38 and a pneumatic pressure source 60 are likewise supported on a wheeled transporter 61 as parts of a complete portable synchronizer system. The pneumatic pressure source 60 is conventional, and is shown in simplified form as an air compressor 62 supplying pressurized air to an accumulator 64 and to the synchronizer module 10 through a manual control valve 65.

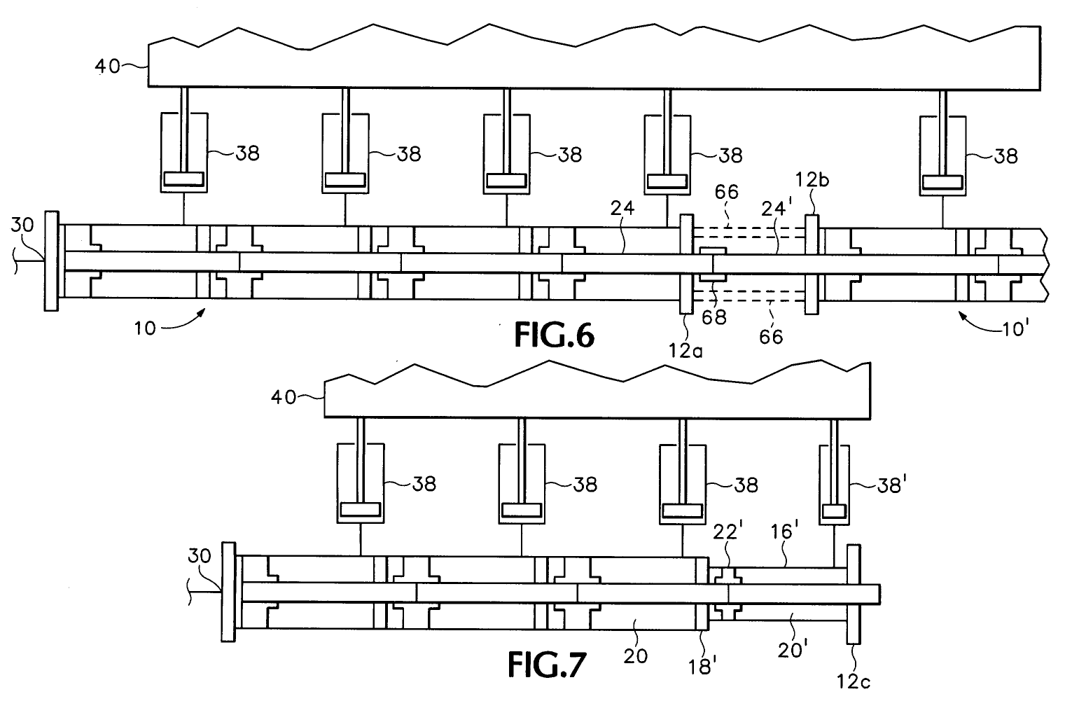

FIG. 6 is a simplified diagrammatic drawing illustrating an exemplary detachable interconnection between a pair of synchronizer modules 10 and 10′ to accommodate more hydraulic actuators 38 than the maximum number which can be synchronized by the module 10 alone. The end flanges 12a and 12b of the two modules are interconnected by threaded spacers 66 passing through holes such as 67 (FIG. 1) to provide a separation of the end flanges of approximately the same length as one of the housings 16. The ends of the respective connecting assemblies 24 and 24′ are threadably interconnected by a suitable collar or flange such as 68 to synchronize the movements of the displacement members of both modules 10 and 10′. The interconnecting collar or flange 68 likewise interconnects the respective fluid passageways 26 of the respective connecting assemblies 24 and 24′.

FIG. 7 is a simplified diagrammatic drawing illustrating the adaptation of a module 10 so as to have fluid-holding chambers 20, 20′ of different fluid-holding volumes, thus enabling the module to synchronize the movements of differently-sized hydraulic actuators 38 and 38′. A smaller chamber 20′, having a fluid-holding cylindrical cross-sectional area less than that of the other chambers 20, is provided in the module 10 for connection to a fluid actuator 38′ of proportionately lesser fluid-holding cylindrical cross-section than the other actuators 38. This is accomplished by removing the tension rods 14, and substituting a smaller housing 16′ and appropriately-modified partition 18′ and end flange 12c accommodating the substitute housing 16′, together with a substitute displacement member 22′ matching the internal dimensions of the housing 16′.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

1. A hydraulic synchronizer for a plurality of hydraulic actuators, said synchronizer comprising:
(a) at least a pair of hydraulic fluid-holding chambers of variable fluid-holding volume;
(b) respective displacement members each movably mounted in a respective chamber so as to change the fluid-holding volume of said respective chamber;
(c) said respective displacement members being interconnected by a connecting assembly so as to cause respective movements of said displacement members to be in predetermined relationship to each other despite differences in resistances to said respective movements;
(d) each respective chamber having an outlet port capable of conducting hydraulic fluid therefrom to a respective one of said hydraulic actuators in response to a decrease in the fluid-holding volume of said respective chamber;
(e) said connecting assembly forming a fluid passageway capable of conducting pressurized fluid to each of said respective displacement members so as to move said displacement members to decrease the fluid-holding volume of each respective chamber.

2. The apparatus of claim 1 wherein said connecting assembly and fluid passageway are located within each of said chambers.

3. The apparatus of claim 1 wherein said fluid passageway is formed by selectively detachable segments of said connecting assembly.

4. The apparatus of claim 1 wherein said fluid passageway is connected to a hydraulic pressure source.

5. The apparatus of claim 1 wherein said fluid passageway is connected to a pneumatic pressure source.

6. The apparatus of claim 1 wherein said synchronizer is supported on wheels.

7. A hydraulic synchronizer for a plurality of hydraulic actuators, said synchronizer comprising:
(a) at least a pair of hydraulic fluid-holding chambers of variable fluid-holding volume;
(b) respective displacement members each movably mounted in a respective chamber so as to change the fluid-holding volume of said respective chamber;
(c) said respective displacement members being interconnected by a connecting assembly so as to cause respective movements of said displacement members to be in predetermined relationship to each other despite differences in resistances to said respective movements;
(d) each respective chamber having an outlet port capable of conducting hydraulic fluid therefrom to a respective one of said hydraulic actuators in response to a decrease in the fluid-holding volume of said respective chamber; and
(e) a fluid passageway connected to a pneumatic pressure source and capable of conducting pneumatic fluid to each of said respective displacement members so as to move said displacement members to decrease the fluid-holding volume of each respective chamber.

8. The apparatus of claim 7 wherein said synchronizer including said pneumatic source is supported on wheels.

9. A hydraulic synchronizer for a plurality of hydraulic actuators, said synchronizer comprising:
(a) at least a pair of hydraulic fluid-holding chambers of variable fluid-holding volume;
(b) respective displacement members each movably mounted in a respective chamber so as to change the fluid-holding volume of said respective chamber;
(c) said respective displacement members being interconnected by a connecting assembly so as to cause respective movements of said displacement members to be in predetermined relationship to each other despite differences in resistances to said respective movements;
(d) each respective chamber having an outlet port capable of conducting hydraulic fluid therefrom to a respective one of said hydraulic actuators in response to a decrease in the fluid-holding volume of said respective chamber; and
(e) a respective relief valve separately associated with each respective chamber enabling hydraulic fluid in each respective chamber to escape from said chamber through said relief valve if fluid pressure in said chamber exceeds a predetermined maximum pressure.

10. The apparatus of claim 9 wherein each respective relief valve is mounted on a respective displacement member so as to enable said hydraulic fluid to escape from said chamber through said respective displacement member.

11. The apparatus of claim 9 wherein each respective chamber has a replenishment port enabling the introduction of hydraulic fluid into the chamber to replace hydraulic fluid which has escaped therefrom through said relief valve.

12. A hydraulic synchronizer for a plurality of hydraulic actuators, said synchronizer comprising:
(a) at least a pair of hydraulic fluid-holding chambers of variable fluid-holding volume;
(b) respective displacement members each movably mounted in a respective chamber so as to change the fluid-holding volume of said respective chamber;
(c) said respective displacement members being interconnected by a connecting assembly so as to cause respective movements of said displacement members to be in predetermined relationship to each other despite differences in resistances to said respective movements;
(d) each respective chamber having an outlet port capable of conducting hydraulic fluid therefrom to a respective one of said hydraulic actuators in response to a decrease in the fluid-holding volume of said respective chamber;
(e) different ones of said hydraulic fluid-holding chambers interconnected by said connecting assembly having different fluid-holding cross-sections for containing hydraulic fluid to be conducted to respective hydraulic actuators of different fluid-holding cross-sections.

13. The apparatus of claim 12 wherein at least one of said chambers is selectively replaceable, separately from another one of said chambers, by a different chamber having a fluid-holding cross-section different from that of said one of said chambers.

14. A hydraulic synchronizer for a plurality of hydraulic actuators, said synchronizer comprising:
(a) at least a pair of modules, each having at least a pair of hydraulic fluid-holding chambers of variable fluid-holding volume;
(b) respective displacement members each movably mounted in a respective chamber so as to change the fluid-holding volume of the respective chamber;
(c) the respective displacement members of each respective module being interconnected by a respective connecting assembly of the respective module so as to cause movements of said displacement members of the respective module to be in predetermined relationship to each other despite differences in resistances to said respective movements;
(d) each respective chamber having an outlet port capable of conducting hydraulic fluid therefrom to a respective one of said hydraulic actuators in response to a decrease in said fluid-holding volume of said respective chamber;
(e) a respective connecting assembly of one of said modules being detachably connectable to a respective connecting assembly of another of said modules to synchronize the movements of the displacement members of said pair of modules.

15. The apparatus of claim 14, each connecting assembly forming a fluid passageway detachably connectable to that of the other connecting assembly and capable of conducting pressurized fluid to each of the respective displacement members of a respective module so as to move said displacement members to decrease said fluid-holding volume.
